(19) United States
(12) Patent Application Publication
(10) Pub. No.: US 2025/0149836 A1
(43) Pub. Date: May 8, 2025

(54) POWER CONVERTER FOR A DATA CABLE

(71) Applicant: Tetra Semiconductors AG, Zürich (CH)

(72) Inventors: Martin Bossard, Zürich (CH); Lars Kamm, Mühlehorn (CH); Roman Willi, Buttikon (CH); Denis Müller, Solothurn (CH)

(21) Appl. No.: 18/503,044

(22) Filed: Nov. 6, 2023

(51) Int. Cl. H01R 13/66; H02M 3/00; H02M 3/158

(52) U.S. Cl. CPC H01R 13/665; H02M 3/003; H02M 3/158

(57) ABSTRACT

A power converter (P) for a data cable (c), the power converter (P) comprises an input (Pi) for establishing an electrical connection with electrical power wires (epw) of the data cable (c), an output (Po), and a converter section (Pc). The converter section (Pc) is configured to: receive electrical power having an input voltage (Vi) from the electrical power wires (epw), and use an inductance (Lc) of the electrical power wires (epw) for converting the electrical power having the input voltage (Vi) into electrical power having an output voltage (Vo), and to transmit the electrical power having the output voltage (Vo) to the output (Po).

### FIELD OF THE INVENTION

The present invention relates to a power converter for a data cable.

### BACKGROUND ART

Data cables according to various standards, such as e.g. multimedia cables according to HDMI standards (HDMI: High-Definition Multimedia Interface), data cables according USB standards such as USB-C (USB: Universal Data Bus), etc., enable transmission of data from a data source, such as e.g. a computer, to a data sink, such as e.g. a computer monitor. Data cables can include electrical power wires for transmission of electrical power and electrical signal wires for transmission of electrical signals. For connecting the data cable to a data source and a data sink, a source connector is arranged at one end, and a sink connector at the other end. The source connector establishes an electrical connection with the source, and the sink connector establishes an electrical connection with the sink.

Depending on the construction quality and materials of data cables, usable lengths are limited in practice. For data cables comprising electrical power and signal wires according to HDMI standards, it is difficult to achieve lengths beyond 13 meters.

In order to achieve longer cable lengths, electrical signal wires can be replaced by optical fibers, such as in e.g. HDMI optical cables. At the source connector, an electro-optic converter is arranged for converting electrical signals into optical signals. The optical signals are transmitted via the optical fibers to the sink end. At the sink connector, an opto-electric converter is arranged for converting optical signals into electrical signals.

Various standards require that data cables must supply electrical power having a predefined voltage to the sink. For example, HDMI standards can require that electrical power having the voltage of 5 V must be supplied to the sink. Furthermore, for data cables which include optical fibers, electrical power must be available at the source connector and at the sink connector for conversion between electrical signals and optical signals.

Increasing the length of data cables increases the length of electrical power wires and thereby increases the electrical resistance between the source connector and the sink connector. The increase of the electrical resistance can have the result that electrical power transmitted by electrical power wires has an unacceptably low voltage at the sink connector, such as e.g. only 4 V or below instead of 5 V as can be required by HDMI standards.

A possible solution to this problem can be to arrange relatively think electrical power wires with a sufficiently small electrical resistance, such as e.g. AWG 10 (AWG: American Wire Gauge). However, thick electrical power wires may result in bulky data cables which may have an unacceptable large diameter.

Another possible solution can be to connect external power supplies to data cables, for example to source connectors and/or sink connectors. However, it may be difficult or inconvenient to connect external power supplies to data cables.

### DISCLOSURE OF THE INVENTION

There may be a need for a power converter for a data cable. There may be a need for a power converter for a data cable, which power converter can be arranged in a sink connector of a data cable.

Such a need may be met with the subject-matter of the independent claims. Advantageous embodiments are defined in the dependent claims.

Ideas underlying embodiments of the present invention may be interpreted as being based, inter alia, on the following observations and recognitions.

An aspect of the invention relates to a power converter for a data cable. The power converter comprises an input for establishing an electrical connection with electrical power wires of the data cable, an output, and a converter section. The converter section is configured to receive electrical power having an input voltage from the electrical power wires. The converter section is configured to use an inductance of the electrical power wires for converting the electrical power having the input voltage into electrical power having an output voltage. The converter section is configured to transmit the electrical power having the output voltage to the output. For long data cables, a voltage received at the input of electrical power wires is degraded at the output because of the electrical resistance of the electrical power wires. By making use of an inductance of the electrical power wires, the power converter enables to restore the degraded voltage to a nominal voltage, in particular to the voltage at the input of the electrical power wires. No additional inductances have to be arranged a particularly small power converter can be provided which can be arranged in standard plugs of data cables.

In some embodiments, the output voltage is larger than the input voltage.

In some embodiments, the converter section includes switches for short-circuiting the electrical power wires during a first period of time, and for connecting the electrical power wires to the output during a second period of time. The power converter is configured in the form of a boost converter while making use of an inductance of the electrical power wires.

In some embodiments, the power converter further includes a control circuit for controlling the switches.

In some embodiments, the power converter further includes a storage for electrical energy which is connected with the output, in particular a capacitor.

In some embodiments, the power converter further comprises a voltage regulator which is configured to receive electrical power having the output voltage from the output and to transmit electrical power having a second output voltage, wherein in particular the second output voltage is smaller than the output voltage. The second output voltage can be used as a supply voltage for a opto-electric converter.

In some embodiments, the power converter further includes a storage for electrical energy which is connected with the second output, in particular a second capacitor.

In some embodiments, the power converter the converter section and if applicable the voltage regulator are arranged on an integrated circuit. Arranging the power converter on an integrated circuit enables a particularly small device.

The invention further relates to a data cable comprising a power converter according to the present invention.

In some embodiments, the data cable has the form of a multimedia cable, in particular according to a HDMI standard.

### BRIEF DESCRIPTION OF THE DRAWINGS

In the following, advantageous embodiments of the invention will be described with reference to the enclosed drawings. However, neither the drawings nor the description shall be interpreted as limiting the invention.

FIG. 1 schematically shows a multimedia cable according to an embodiment of the present invention.

FIG. 2 schematically shows a power converter according to an embodiment of the present invention.

FIG. 2a schematically shows power wires of a multimedia cable which receive a supply voltage from a source and transmit a modified supply voltage to a sink.

FIG. 3a, 3b schematically show operating states during different time intervals of a power converter according to an embodiment of the present invention.

FIG. 4 schematically shows an output voltage of a power converter according to an embodiment of the present invention.

FIG. 5 schematically shows possible cable lengths of a multimedia cable according to an embodiment of the present invention.

The figures are only schematic and not to scale. Same reference signs refer to same or similar features.

### MODE(S) FOR CARRYING OUT THE INVENTION

In the following, the invention is illustrated for the case of a data cable having the form of a multimedia cable, such as a multimedia cable according to a HDMI (HDMI: High Definition Multimedia Interface) standard. However, the invention is not limited to multimedia cables and can be applied to other data cables, such as a data cable according to a USB standard (USB: universal data bus).

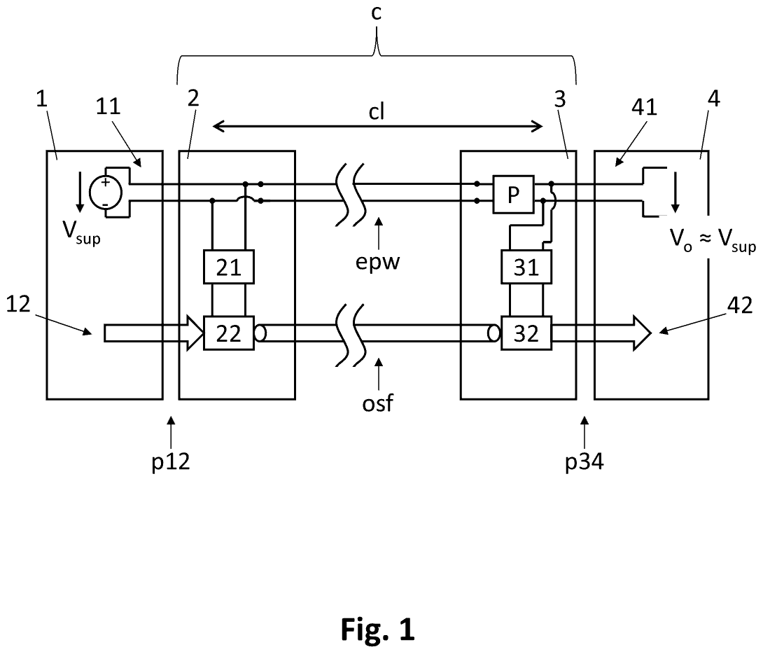

FIG. 1 schematically shows a multimedia cable c according to an embodiment of the present invention. The multimedia cable c is configured to connect a multimedia source 1 with a multimedia sink 4. The multimedia source 1 can relate e.g. to a computer, a Blu-ray player, or any other multimedia source. The multimedia sink 4 can relate e.g. to a computer monitor, a beamer, or any other multimedia sink. In some embodiments, the multimedia source 1, the multimedia cable c and the multimedia sink 4 conform with a HDMI standard (HDMI: High-Definition Multimedia Interface), or with any other standard specifying connecting a multimedia source with a multimedia cable to a multimedia sink.

As schematically illustrated in FIG. 1, the multimedia cable c includes a source connector 2 and a sink connector 3. The source connector 2, or in other words the source plug, is configured to electrically connect with the multimedia source 1 via pins p12. The pins p12 electrically connect electrical lines of the multimedia source 1 with corresponding electrical lines of the source connector 2. The sink connector 3, or in other words the sink plug, is configured to electrically connect with the multimedia sink 4 via pins p34. The pins p34 electrically connect electrical lines of the sink connector 3 with corresponding electrical lines of the multimedia sink 4. For example, HDMI standards specify 19 pins for connecting electrical lines of the source with the source connector respectively for connecting electrical lines of the sink connector with the sink.

As schematically illustrated in FIG. 1, the multimedia source 1 includes a power source having a predefined supply voltage Vsup for transmitting electrical power. Accordingly, the electrical lines at the source 1 and at the source connector 2 include source electrical power lines 11 connected with the power source Vsup. For example, according to HDMI standards, the predefined supply voltage Vsup is 5 V. Furthermore, the multimedia source 1 includes signal sources. Accordingly, the electrical lines of the multimedia source 1 and the source connector 2 include source electrical signal lines 12 connected with the signal sources. Furthermore, the electrical lines of the sink connector 3 and the multimedia sink 4 include sink electrical power lines 41 for receiving electrical power having the predefined supply voltage Vsup at the multimedia sink 4. Furthermore, the electrical lines of the sink connector 3 and the multimedia sink 4 include sink electrical signal lines 42 for receiving electrical signals at the multimedia sink 4.

Electrical power can enable operation of electrical equipment at the sink. Electrical signals can relate to audio signals, video signals, etc. and enable, for example, displaying, playing back, etc. a desktop, an application window, an audio stream, a video stream, etc. of a computer with a computer monitor.

As illustrated in FIG. 1, the multimedia cable c has a cable length cl. In some embodiments, the multimedia cable as a long cable length cl of at least 10 m. In the following, the definition “long” specifies a cable length cl of at least 10 m.

While it is difficult to transmit electrical signals using long multimedia cables having electrical signal wires, optical signal fibers enable transmitting optical signals over long multimedia cables.

As illustrated in FIG. 1, the multimedia cable c includes electrical power wires epw and optical signal fibers osf. Only a pair of electrical power wires epw can be arranged. Only a single optical signal fiber osf can be arranged. A plurality of electrical power wires epw can be arranged. A plurality of optical signal fibers osf can be arranged.

As illustrated in FIG. 1, the source electrical signal lines 12 are connected to an electro-optic converter 22, which is further connected to the optical signal fibers osf of the multimedia cable c, which is further connected to a opto-electric converter 32, which is further connected to the sink electrical signal lines 42. The electro-optic converter 22 converts the electrical signals received from the source electrical signal lines 12 into optical signals, which are transmitted via the optical signal fibers osf to the opto-electric converter 32. The opto-electric converter 32 receives the optical signals from the optical signal fibers osf and converts the optical signals into electrical signals, which are transmitted via the sink electrical signal lines 42 to the multimedia sink 4. Accordingly, transmission of electrical signals from the multimedia source 1 to the multimedia sink 4 is enabled for long multimedia cables.

According to multimedia standards, such as HDMI standards, multimedia cables must deliver electrical power having a predefined supply voltage at the sink connector.

However, it is difficult to transmit electrical power at a predefined supply voltage Vsup over long electrical power wires epw, because an electrical resistance of long electrical power wires epw results in a voltage loss.

As illustrated in FIG. 1, the source electrical power lines 11 are connected via electrical power wires epw to a power converter P, which will be described in more detail further below. The power converter P is further connected to the sink electrical power lines 41. Electrical power having a supply voltage Vsup at the multimedia source 1 is transmitted from the multimedia source 1 via the electrical power lines 11 and via the electrical power wires epw to the power converter P. Because of the electrical resistance of the electrical power wires epw, the power converter P receives electrical power having a voltage which is below the supply voltage Vsup. The power converter P is configured to convert the received electrical power having the received voltage back to electrical power having the supply voltage Vsup, and to transmit electrical power having the supply voltage Vsup to the sink electrical power lines 41. Accordingly, transmission of electrical power having the supply voltage Vsup from the multimedia source 1 to the multimedia sink 4 is enabled for long multimedia cables.

For operation, the electro-optic converter 22 must receive electrical power having a predefined voltage, such as 3.3 V.

As illustrated in FIG. 1, the source connector 2 includes a source voltage regulator 21, such as a low-dropout regulator. The source voltage regulator 21 is connected to the source electrical power lines 11. The source voltage regulator 21 is connected to the electro-optic converter 22. The source voltage regulator 21 is configured to receive electrical power having the predefined voltage Vsup from the source electrical power lines 11 and to transmit electrical power having a predefined voltage to the electro-optic converter 22 for operating the electro-optic converter 22. Thus, the electro-optic converter 22 receives electrical power.

For operation, the opto-electric converter 32 must receive electrical power having a predefined voltage, such as 3.3 V.

As illustrated in FIG. 1, the sink connector 3 includes a sink voltage regulator 31, such as a low-dropout regulator. The sink voltage regulator 31 is connected to the sink electrical power lines 41. The sink voltage regulator 31 is connected to the opto-electric converter 32. The sink voltage regulator 31 is configured to receive electrical power having the predefined voltage Vsup from the sink electrical power lines 41 and to transmit electrical power having a predefined voltage to the opto-electric converter 32 for operating the opto-electric converter 32. Thus, the opto-electric converter 32 receives electrical power.

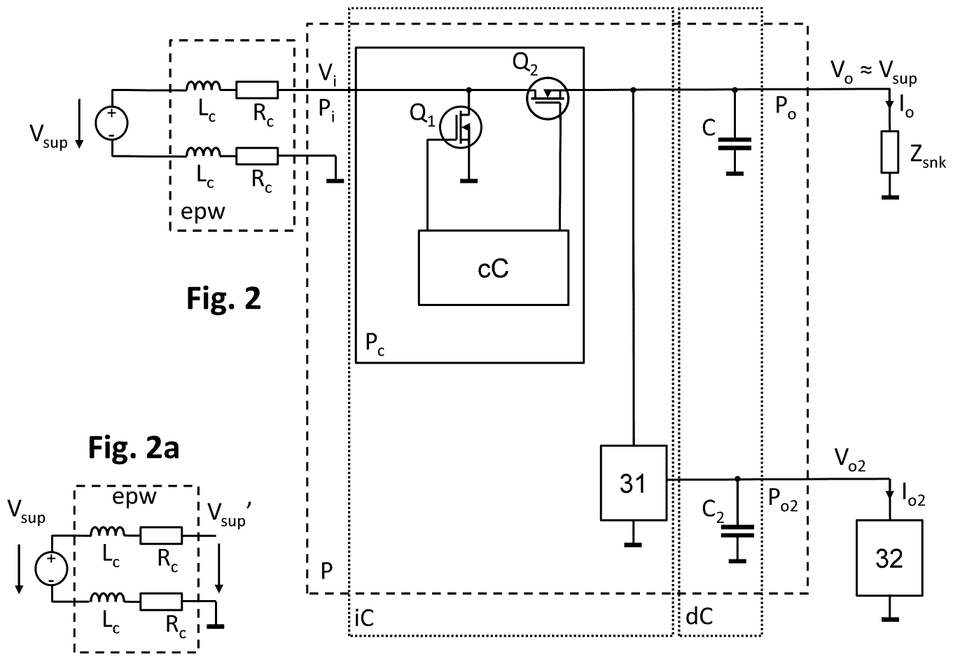

FIG. 2 schematically shows a power converter P according to an embodiment of the present invention. The electrical power wires epw are connected from the supply having supply voltage Vsup of the source 1 to an input Pi of the power converter P. The electrical power wires epw include a first electrical power wire and a second electrical power wire. The second electrical power wire is connected to mass. The first electrical power wire is connected to a converter section Pc. The converter section Pc is configured to receive electrical power having an input voltage Vi from the electrical power wires epw.

FIG. 2a schematically shows power wires epw of a multimedia cable c which receive a supply voltage Vsup from a source and transmit a modified supply voltage Vsup′ to a sink. Because of the electrical resistance Rc of long electrical power wires, the modified supply voltage Vsup′ is smaller than the supply voltage Vsup.

The converter section Pc is configured to use an inductance Lc of the electrical power wires epw for converting the electrical power having the input voltage Vi into electrical power having an output voltage Vo. The power converter P is configured to transmit the electrical power having the output voltage Vo to an output Po of the power converter. The power converter is configured to provide an output voltage Vo which is larger than the modified supply voltage Vsup′. For example, the power converter P can be configured to enable an output voltage Vo which is approximately the supply voltage Vsup. According to HDMI standards, the supply voltage Vsup and the output voltage Vo can be 5 V.

Because the converter section Pc uses the inductance Lc of the electrical power wires epw, no further inductor is required for operation of the power converter P. Accordingly, the size of the power converter P is particularly small. Thus, the power converter P can be arranged in the sink connector 3 of a multimedia cable c. Using such a multimedia cable c is convenient, in particular because electrical power wires epw having a small diameter can be arranged enabling multimedia cables which are not bulky, and because no external power supplies must be arranged.

As illustrated in FIG. 2, the converter section Pc includes a first transistor Q1 which is connected between the first electrical power wire epw and mass, and a second transistor Q2 which is connected between the first electrical power wire epw and the output Po. The converter section Pc further includes a control circuit cC which is configured to control the transistors Q1, Q2. For example, the control circuit cC receives power via output voltage Vo. During a first period of time Ts, the first transistor Q1 is controlled to connect the first electrical power wire epw to mass, thereby short-circuiting the electrical power wires epw. During the first period of time Ts, the second transistor Q2 is operated to disconnect the first electrical power wire epw from the output Po. During a second period of time TI, the second transistor Q2 is operated to connect the first electrical power wire epw to the output Po. During the second period of time TI, the first transistor Q1 is operated to disconnect the first electrical power wire epw from mass.

As illustrated in FIG. 2, a capacitor C is arranged between the output Po and mass. The capacitor C forms a low-pass filter. Any other low-pass filter can be arranged.

As illustrated in FIG. 2, the power converter P can include a voltage regulator 31, such as a low-dropout regulator, for operating a opto-electric converter 32 of the sink connector 3. The voltage regulator 31 is connected to the output Po of the power converter, and is configured to provide at a second output Po2 of the power converter electrical power having a second output voltage Vo2. A second capacitor C2 can be connected between the second output Po2 and mass.

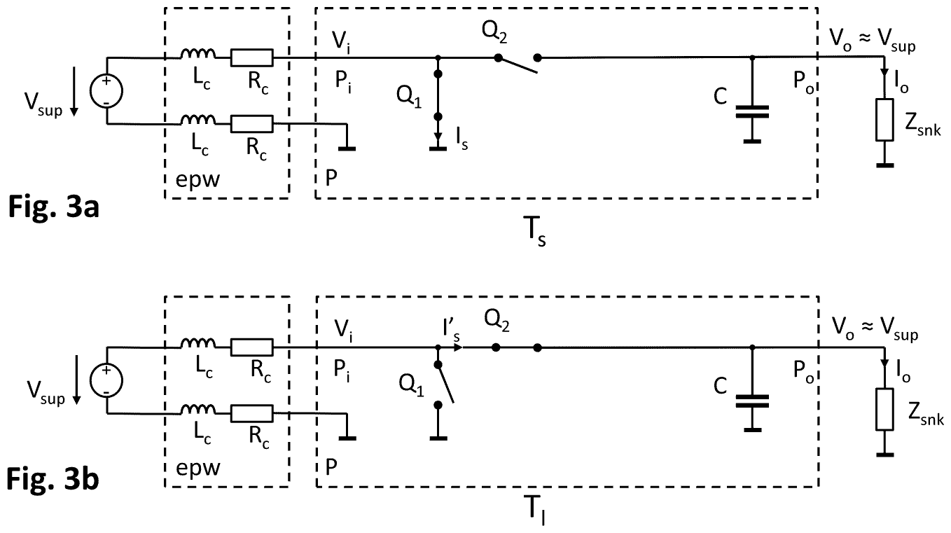

As illustrated in FIG. 3, the power converter P includes a first section iC which includes circuits Q1, Q2, cC, 31 which can be arranged on an integrated circuit, and a second section dC which includes discrete circuits C, C2. Integrated circuits have a particularly small size, thereby simplifying arranging the power converter P in a sink connector 3 of a multimedia cable c.

FIG. 3a, 3b schematically show operating states during different time intervals Ts, TI of a power converter P according to an embodiment of the present invention. During a first period of time Ts, the first electrical power wire epw is connected to mass and disconnected from the output Po. A current flows from the supply having supply voltage Vsup to the first electrical power wire epw and to mass, which current Is also flows from mass through the second electrical power wire to the supply having supply voltage Vsup. Because of the inductance Lc of the electrical power wires epw, a magnetic field is built up in the electrical power wires epw. During a second period of time TI, which follows the first period of time Ts, the first electrical power wire is disconnected from mass and connected to the output Po. Because of the magnetic field which was built up in the electrical power wires epw during the first period of time, a current I's flows from the electrical power wires epw to the output Po. A capacitor C is connected between the output Po and mass. During the second period of time TI, an electric filed is built up in the capacitor C, wherein the capacitor C is loaded with electrical energy. During the first period of time Ts, electrical energy is transmitted from the capacitor C to the sink having impedance Zsnk.

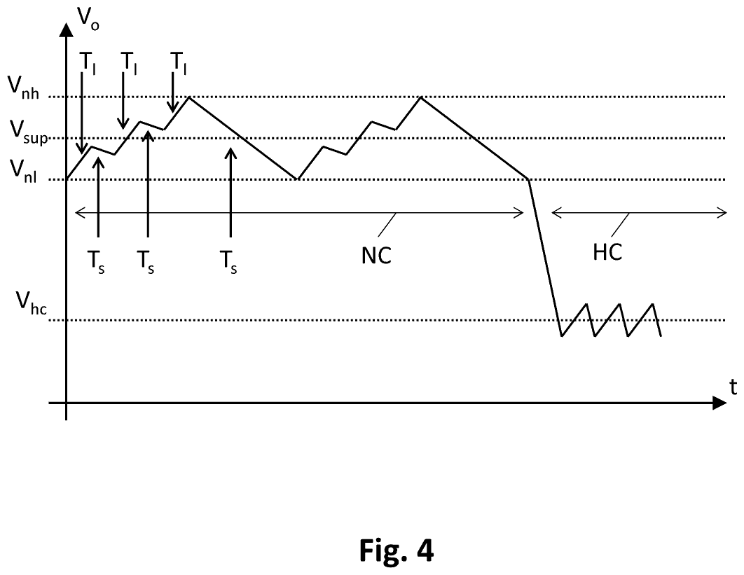

FIG. 4 schematically shows an output voltage Vo of a power converter P according to an embodiment of the present invention. As described above, during time intervals Ts a magnetic field is built up in the electrical power wires epw, and during time intervals TI, an electric field is built up in the capacitor C. The control circuit cC is configured to control the transistors Q1, Q2 such that the output voltage Vo remains within limits Vnl, Vnh during first times NC when the output current Io of the power converter P is a nominal current, such as e.g. 50 mA or 80 mA. Other control schemes than the illustrated two-point regulator can be applied for regulating the output voltage Vo to a nominal voltage. The control circuit cC is configured to control the transistors Q1, Q2 such that the output voltage Vo is reduced to Vhc during second times HC when the current Io provided by the power converter P is a high current, such as e.g. more than 100 mA. The output current Io of the power converter P depends on the impedance Zsnk of the sink which is connected to the output Po of the power converter P.

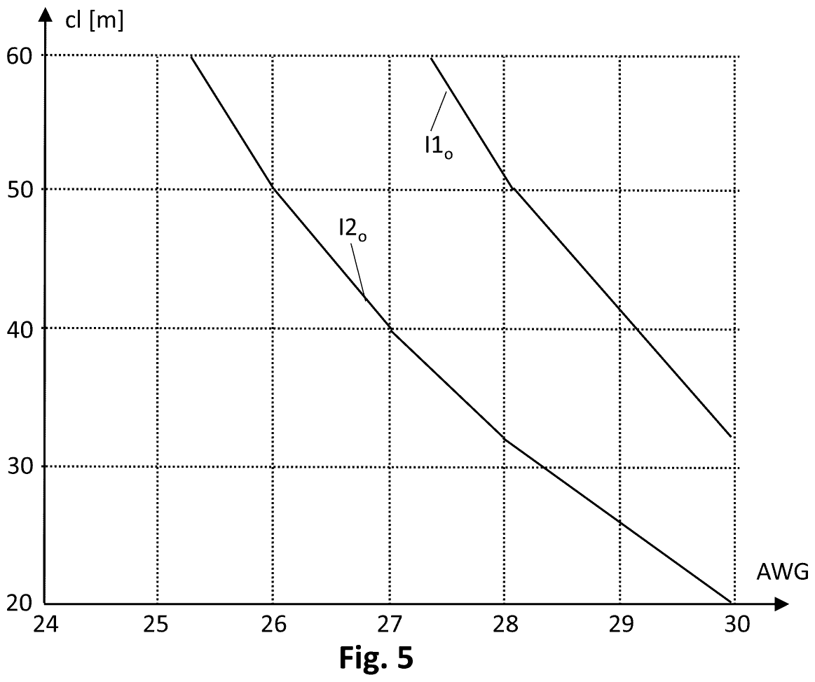

FIG. 5 schematically shows possible cable lengths cl of a multimedia cable c according to an embodiment of the present invention. For a desired output voltage Vo, such as 4.8 V, the cable lengths depend on the AWG of the electrical power wires epw, and on the output current Io. For example, according to FIG. 5, cable lengths of between more than 30 m and more than 60 m can be achieved for electrical power wires epw having an AWG of between 30 and 27 for an output current I2o of 50 mA. For example, according to FIG. 5, cable lengths cl of between 20 m and more than 60 m can be achieved for electrical power wires epw having an AWG of between 30 and 25 for an output current I2o of 80 mA.

Finally, it should be noted that the term “comprising” does not exclude other elements or steps and the “a” or “an” does not exclude a plurality. Also elements described in association with different embodiments may be combined. It should also be noted that reference signs in the claims should not be construed as limiting the scope of the claims.

LIST OF REFERENCE SIGNS

| | |
|---|---|
| 1 | multimedia source |
| 4 | multimedia sink |
| c | multimedia cable |
| cl | cable length |
| 2 | source connector |
| 3 | sink connector |
| 11 | source electrical power lines |
| 12 | source electrical signal lines |
| 41 | sink electrical power lines |
| 42 | sink electrical signal lines |
| epw | electrical power wires |
| osf | optical signal fibers |
| p12 | pins for electrically connecting |
| | source connector to the source |
| p34 | pins for electrically connecting |
| | sink connector to the sink |
| Vsup | supply voltage provided by |
| | multimedia source |
| 21 | source voltage regulator |
| 22 | electro-optic converter |
| P | power converter |
| Pi | input of power converter |
| Po | output of power converter |
| Pc | converter section of power |
| | converter |
| Po2 | second output of power |
| | converter |
| Vi | voltage received at input of |
| | power converter |
| Vo | output voltage provided by |
| | power converter |
| Zsnk | electrical impedance of sink |
| | load |
| Io | output current provided by |
| | output of power converter |
| Vo2 | second output voltage provided |
| | by power converter |
| Io2 | second output provided by |
| | output of power converter |
| 31 | sink voltage regulator |
| 32 | opto-electric converter |
| Q1, Q2 | first and second switch |
| Ts, Tl | first and second period of time |
| cC | control circuit |
| iC | integrated circuits |
| dC | discrete circuits |
| C | capacitor |
| C2 | second capacitor |

1. A power converter for a data cable, the power converter comprising:
an input for establishing an electrical connection with electrical power wires of the data cable,
an output, and
a converter section configured to:
receive electrical power having an input voltage from the electrical power wires, and
use an inductance of the electrical power wires for converting the electrical power having the input voltage into electrical power having an output voltage, and
to transmit the electrical power having the output voltage to the output.

2. The power converter according to claim 1, wherein the output voltage is larger than the input voltage.

3. The power converter according to claim 1, wherein the converter section includes switches for short-circuiting the electrical power wires during a first period of time, and for connecting the electrical power wires to the output during a second period of time.

4. The power converter according to claim 3, further including a control circuit for controlling the switches.

5. The power converter according to claim 1, further including a storage for electrical energy which is connected with the output, in particular a capacitor.

6. The power converter according to claim 1, further comprising a voltage regulator which is configured to receive electrical power having the output voltage from the output and to transmit electrical power having a second output voltage, wherein in particular the second output voltage is smaller than the output voltage.

7. The power converter according to claim 6, further including a storage for electrical energy which is connected with the second output, in particular a second capacitor.

8. The power converter according to claim 6, wherein the converter section and the voltage regulator are arranged on an integrated circuit.

9. A data cable comprising:
a power converter comprising:
an input for establishing an electrical connection with electrical power wires of the data cable,
an output, and
a converter section configured to:
receive electrical power having an input voltage from the electrical power wires, and
use an inductance of the electrical power wires for converting the electrical power having the input voltage into electrical power having an output voltage, and
to transmit the electrical power having the output voltage to the output.

10. The data cable according to claim 9 having the form of a multimedia cable according to a HDMI standard.

11. The data cable according to claim 9, wherein the output voltage is larger than the input voltage.

12. The data cable according to claim 9, wherein the converter section includes switches for short-circuiting the electrical power wires during a first period of time, and for connecting the electrical power wires to the output during a second period of time.

13. The data cable according to claim 12, further including a control circuit for controlling the switches.

14. The data cable according to claim 9, further including a storage for electrical energy which is connected with the output, in particular a capacitor.

15. The data cable according to claim 9, further comprising a voltage regulator which is configured to receive electrical power having the output voltage from the output and to transmit electrical power having a second output voltage, wherein in particular the second output voltage is smaller than the output voltage.

16. The data cable according to claim 15, further including a storage for electrical energy which is connected with the second output, in particular a second capacitor.

17. The data cable according to claim 15, wherein the converter section and the voltage regulator are arranged on an integrated circuit.
